(19) United States
(12) Patent Application Publication
(10) Pub. No.: US 2022/0007692 A1
(43) Pub. Date: Jan. 13, 2022

(54) POLY-ALBUMEN BASED GREEN COATING TO ENHANCE SHELF LIFE OF PERISHABLE FOODS

(71) Applicant: William Marsh Rice University, Houston, TX (US)

(72) Inventors: Muhammad M. RAHMAN, Houston, TX (US); Seohui JUNG, Houston, TX (US); Neethu POTTACKAL, Houston, TX (US); Pulickel M. AJAYAN, Houston, TX (US)

(73) Assignee: William Marsh Rice University, Houston, TX (US)

(21) Appl. No.: 17/373,316

(22) Filed: Jul. 12, 2021

Related U.S. Application Data
(60) Provisional application No. 63/050,987, filed on Jul. 13, 2020.

(51) Int. Cl. A23L 3/3571; A23L 3/3472; A23L 3/349

(52) U.S. Cl. CPC A23L 3/3571; A23L 3/349; A23L 3/3472

(57) ABSTRACT

The present disclosure is directed to poly-albumen polymer based edible film for fruit and vegetable preservation and methods for use thereof. This multifunctional bionanocomposite is comprised largely of egg-derived polymers and cellulose nanomaterials as a conformal coating onto fresh produce that slows down food decay by retarding ripening, dehydration, and microbial invasion. The coating is edible, washable, and made from readily available inexpensive or waste materials which makes it a promising economic alternative to commercially available fruit coatings and a solution to combat food wastage that is rampant in the world.

### PRIORITY CLAIM

This application claims benefit of priority to U.S. Provisional Application Ser. No. 63/050,987, filed Jul. 13, 2020, the entire contents of which are hereby incorporated by reference.

### BACKGROUND

### 1. Field of the Disclosure

The present disclosure relates generally to the fields of food chemistry and food preservation. More particular, the disclosure relates to a poly-albumen-based green polymer/film coating and its use to enhance shelf-life of perishable foods.

### 2. Background

World hunger is a rising issue; however, a third of the food produced around the globe is wasted and never consumed (Nature Editorial, 2019). This is largely due to perishable foods expiring during or shortly after the time it takes to distribute foods from farms to retail stores. The issue is especially prominent in fresh produce such as fruits and vegetables where around 40-50% of crops produced in the field are wasted every year (Global Food Losses and Food Waster, 2011). A major challenge is that produce is easily perishable with a shelf life of only a few days once they reach retailors. The main factors affecting the quality and post-harvest life of such produces are attributed to water loss or dehydration, texture deterioration, respiration and senescence processes, and microbial growth. Development of a cost-effective and green solution to extend the shelf life of produce by controlling these factors is paramount in alleviating food wastage.

Various methods have been reported to improve the shelf life of perishable fruits by controlling some of the factors known to accelerate degradation: microbial growth, dehydration, temperature (Han et al., 2018; Jongen, 2002; Ahvenainen, 2003). In addition to lengthening the shelf life of foods, it is also imperative that any method is biocompatible, biodegradable, have antimicrobial properties, be capable of forming a uniform membrane, and be safe for human consumption. Commercially, several preservation technologies are used to increase the shelf life of fruits (Jongen, 2005). One common method is fruit waxing which extends shelf life by artificially coating the fruits in preservatives using weak organic acids and their derivatives. However, on entering the human body, the gut cells fragment the preservatives into ions to maintain the physiological balance, resulting in several adverse effects including ion accumulation, membrane disruption, essential metabolite inhibition, draining energy to restore the homeostasis, and reductions in body-weight gain (Bracy et al., 1998; Krebs et al., 1983). Other prevalent methods to increase shelf-life include refrigeration, modified atmospheric packaging (MAP) with increased concentrations of carbon dioxide, and paraffin-based active coatings. However, these methods are expensive, time-consuming, visually alter the appearance of fruits, and affect the flavor of fruits. Therefore, there is a critical need for alternative green strategies to increase the shelf-life of perishable foods without altering the biological, physicochemical, and physiological characteristics of the products.

Recently, natural materials such as polysaccharides, proteins, lipids, chitosan, and alginate have been increasingly used in post-harvest preservation of fruits and vegetables (Mkandawire and Aryee, 2018; Patel, 2020; Tao et al., 2012). However, none of the developed materials displays distinctive properties in multiple important requirements of fruit preservation including preservation effectiveness, material flexibility, edibility, washability, and appearance, indicating a need for a more multifunctional coating material. The animal egg is an especially promising product to preserve fruits because it exhibits high protein and lipid content and accounts for up to ˜2% of food waste in the USA (Rahman et al., 2014; Chang et al., 2011). Thus, if eggs that would potentially end up as waste could instead be used to preserve other food items, then this would represent a sustainable and economically efficient method to reduce the perishability of food.

### SUMMARY

Thus, in accordance with the present disclosure, there is provided a composition comprising poly-albumen, cellulose nanocrystals (CNCs), and an external plasticizer. The poly-albumen may be derived from whole egg or egg white proteins. The external plasticizer may be a polyol, such as a low molecule weight polyol, such as glycerol, ethyleneglycol (EG), diethylene glycol (DEG), triethylene glycol(TEG), tetraethylene glycol, propylene glycol (PG), and polyethylene glycol (PEG) or a sugar alcohol such as sorbitol, mannitol, maltitol, xylitol, erythritol or isomalt, or monosaccharides (glucose, mannose, fructose, sucrose). The composition may comprise an anti-microbial and/or antioxidant, such as curcumin, riboflavin or cinnamaldehyde. The curcumin, cinnamaldehyde, and/or riboflavin may be crosslinked with said poly-albumen.

The CNCs may be present at about 15-45 wt % of said poly-albumen. The external plasticizer may be present at about 10-40 wt % of said poly-albumen. The anti-microbial and/or antioxidant may be present at about 1-10 wt % of said poly-albumen. The composition may further comprise egg yolk protein, such as at about 10-20 wt % of said poly-albumen. The CNCs may have a length and/or diameter of less than 1 μm, or less than 500 nm, or less than 250 nm, such as a length of about 90-130 nm and a diameter of about 4-8 nm. The CNCs may have a crystallinity index of about 84%. The composition may have a basic pH, such as about pH 8.0-12, or about pH 10.0.

Also provided is a perishable food product coated with the composition as described in the present disclosure. The product may be a fruit or vegetable, such as a climacteric or non-climacteric fruit or vegetable. The climacteric fruit may be apple, avocado, banana, breadfruit, cherimoya, durian, feijoa, fig, guava, kiwifruit, mango, muskmelon, papaya, passion fruit, pears, persimmon, plantain, quince, sapodilla, sapote, soursop, tomato or stone fruit (apricots, nectarines, peaches, plums). The non-climacteric fruit may be strawberry, blueberry, blackberry, pineapple, grape, raspberry, cherry, orange, lime, lemon, or grapefruit. The climacteric vegetable may be cantaloupe or potato. The non-climacteric vegetable may be cucumber, eggplant, pepper, summer squash or watermelon. The product may be an egg or a nut, such as a shelled nut.

In yet another embodiment, there is provided a method of preparing a food preserving composition comprising (a) dissolving poly-albumen in an aqueous solution, optionally including adjusting the pH of the dissolved poly-albumen solution to be at or greater than pH 8.0 and a temperature of 50-80° C.; (b) adding an external plasticizer to the solution of step (a); (c) adding cellulose nanocrystals (CNCs) to the solution of step (b). The poly-albumen may be derived from whole egg or egg white proteins. The external plasticizer may be a polyol, such as a low molecule weight polyol, such as glycerol, ethyleneglycol (EG), diethylene glycol (DEG), triethylene glycol(TEG), tetraethylene glycol, propylene glycol (PG), and polyethylene glycol (PEG) or a sugar alcohol such as sorbitol, mannitol, maltitol, xylitol, erythritol or isomalt, or monosaccharides (glucose, mannose, fructose, sucrose). The food preserving composition may further comprise an anti-microbial and/or antioxidant. The anti-microbial may be cinnamaldehyde, riboflavin or curcumin. The curcumin, cinnamaldehyde, and/or riboflavin may be crosslinked with said poly-albumen. The CNCs may be present at about 15-45 wt % of said poly-albumen. The external plasticizer may be present at about 10-40 wt % of said poly-albumen. The anti-microbial and/or anti-oxidant may be present at about 1-20 wt % of said poly-albumen. The method may further comprise, after step (b) and before step (c), adding egg yolk protein, such as at about 10-20 wt % of said poly-albumen.

In yet another embodiment, there is provided a method of preparing a food preserving composition comprising (a) dissolving poly-albumen in an aqueous solution, optionally including adjusting the pH of the dissolved poly-albumen solution to be at or greater than pH 8.0 and a temperature of 50-80° C.; (b) adding an external plasticizer to the solution of step (a); (c) adding cellulose nanocrystals (CNCs) to the solution of step (b). The poly-albumen may be derived from whole egg or egg white proteins. The external plasticizer may be a polyol, such as a low molecule weight polyol, such as glycerol, trimethylolpropate or pentaerythritol or a sugar alcohol such as sorbitol, maltitol, xylitol, erythritol or isomalt. The food preserving composition may further comprise an anti-microbial and/or anti-oxidant. The anti-microbial may be cinnamaldehyde, riboflavin or curcumin. The cinnamaldehyde, riboflavin and/or curcumin may be crosslinked with said poly-albumen. The CNCs may be present at about 15-45 wt % of said poly-albumen. The external plasticizer may be present at about 15-45 wt % of said poly-albumen. The anti-microbial and/or anti-oxidant may be present at about 1-20 wt % of said poly-albumen. The method may further comprise, after step (b) and before step (c), adding egg yolk protein, such as at about 10-20 wt % of said poly-albumen.

The use of the word “a” or “an” when used in conjunction with the term “comprising” in the claims and/or the specification may mean “one,” but it is also consistent with the meaning of “one or more,” “at least one,” and “one or more than one.” The word “about” means plus or minus 5% of the stated number.

It is contemplated that any method or composition described herein can be implemented with respect to any other method or composition described herein. Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIGS. 1A-E. Fabrication and characterization of cellulose nanocrystal reinforced poly(albumen) nanocomposite coating. (FIG. 1A) Schematic illustration of the nanocomposite synthesis and dip-coating process on fruits. Egg albumen and glycerol are mixed in DI water and the pH is adjusted to 10. The solution is heated and egg yolk and curcumin are added stepwise into the solution. Cellulose nanocrystals as reinforcement are dispersed into the final solution. After cooling down, the nanocomposite solution is dip-coated onto fruits. (FIG. 1B) Viscosity measurement of the nanocomposite coating as a function of shear rate displaying shear-thinning behavior. (FIG. 1C) Contact angle of the nanocomposite coating on different climacteric fruit surfaces (banana, papaya, and avocado) as a function of time. (FIG. 1D) Optical image of a sessile droplet of coating on different fruit peels at t=0 and t=500 s. (FIG. 1E) Laser Scanning Confocal Fluorescence Microscopy of uncoated and coated yellow banana peel at excitation wavelengths of 405, 488, and 594. Images of the outer surface (top row) of the uncoated yellow banana peel showing separately acquired blue (B; 405), green (G; 488), and red (R; 594) channels. Images of the outer surface (middle row) of the thinly coated yellow banana peel, showing separately acquired blue (B; 405), green (G; 488), and red (R; 594) channels. In addition to the underlying cell-wall morphology observed in the blue and green channels, the thin layer of coating is observed in the green and red channels. Cross-section of a thinly coated yellow banana peel (bottom) observed at 488 and 594 nm. A total of six images were similarly processed. Frequency distribution of thickness measurements revealed a thickness range between 23˜33 μm with a 95% confidence interval (N=30).

FIGS. 2A-E. Effect of nanocomposite coating on fruit ripeness. (FIG. 2A) Time-lapse photographs of bare (uncoated) and coated climacteric fruits. Coated fruits show significantly less change in appearance. (FIG. 2B) Time-lapse photographs of the inner appearance of bare and coated fruits. Coated fruits show a slowed ripening process. (FIG. 2C) Time-lapse photographs of bare and coated non-climacteric fruit. (FIG. 2D) Stiffness of bare and coated climacteric fruits up to 11 days after being bought. Coated fruits show significantly higher stiffness (p<0.05). (FIG. 2E) Weight loss of bare and coated strawberry as a function of time after purchase. Coated fruits exhibit lower weight reductions.

FIGS. 3A-D. Characterization of nanocomposite film to understand the slow ripening process in coated fruits. (FIG. 3A) Photograph of a 70-μm thick cellulose nanocrystal reinforced poly(albumen) nanocomposite film. The yellowish film is showing extreme flexibility and foldability. (FIG. 3B) AFM 3D image of nanocomposite's topology. (FIG. 3C) Contact angle of a sessile water droplet on nanocomposite film as a function of time. The decrease in contact angle with time indicates the partial wettability or hydrophilicity of the dried coating. (FIG. 3D) Water vapor transmission rate (WVTR) of the nanocomposite film compared to common biopolymers used as a coating. The coating has comparably lower WVTR, which explains its distinction in preserving fruit freshness and reducing weight loss over time.

FIGS. 4A-D. Gas barrier, edibility, antimicrobial, and washability properties of the nanocomposite films. (FIG. 4A) Oxygen permeability (OP) of the nanocomposite film compared to other common coating materials. The coating has comparably lower OP, which slows down the fruit respiration and prevents ripening. (FIG. 4B) Bacterial titer on control and the nanocomposite film immediately and after overnight incubation. The nanocomposite eliminated all bacteria within 24 h, showing an excellent antimicrobial property. (FIG. 4C) Panco2 cell survival percentage after incubation with different concentrations of the coating. The coating shows no toxicity to mammalian cells which infers the edibility of the material. (FIG. 4D) Solubility of nanocomposite film in DI water as a function of time. The coating completely disintegrates within 2 min, demonstrating that it could easily be washed off the fruit before consumption.

FIG. 5. Transmission electron microscopy of cellulose nanocrystals (CNCs).

FIG. 6. Atomic force microscopy of cellulose nanocrystals (CNC) at lower and higher magnification. A representative AFM image of CNCs, showing both individual crystals and agglomerates, similar to other results obtained in literature (Barbosa et al., 2016; Varanasi et al., 2018). The crystals have a rod-like morphology and, typically, they have a distribution in length that varies between 80-140 nm and the diameter varies between 4-7 nm. Both the TEM and AFM images confirm the size and shape of the cellulose nanocrystals used in this study. Based on 10 measurements, the ζ-potential value is found to be around −48.0 mV, showing that the CNCs are well-dispersed in water (Table S2). Also, the sulfate groups are present in the crystalline domain of CNCs that contributed to the negative zeta potential. Generally, particles with ζ-potential values greater than ±30 mV are considered moderately stable and less than ±30 mV is unstable in a colloidal system.

FIG. 7. X-ray diffraction (XRD) patterns of CNCs. X-ray diffraction patterns of CNC film. The sample showed three distinctive diffraction peaks at 2θ=16.4°, 18.4°, and 22.7°, which are assigned to the cellulose I crystalline structure. The sharp diffraction peak for the (200) plane at 2θ=22.6° indicated high perfection of the crystal lattice. As shown in the figure, the diffraction pattern displayed 6 distinct peaks (Table S3) which are deconvoluted to calculate crystallinity index.

FIG. 8. Infrared spectra of CNC prepared by acid hydrolysis. Infrared spectra of cellulose nanocrystals. The large band at 3000-3500 cm⁻¹ is assigned to —OH stretching due to cellulose I and near 2900 cm⁻¹ is assigned to —CH stretching. Cellulose II has two characteristic peaks at 3440 and 3480 cm⁻¹ and cellulose I has various —OH peaks below 3400 cm⁻¹ (Lee et al., 2013). The region of 800-1500 cm⁻¹ is a unique fingerprint region for cellulose where the majority of peaks in that range were found, indicating that acid hydrolyzed nanocellulose maintained a similar chemical structure to the original cellulose species. It is noted that the CNCs are not free of sulfate groups. It contains very small fraction of (˜1.1%) sulfur on dry CNC sodium form as measured by FPL. To confirm, IR spectra has been performed and provided in FIG. 8. The FTIR showed two peaks at 1200 cm⁻¹ and 810 cm⁻¹ for CNCs which is assigned to the sulfate half-ester groups produced by sulfuric acid hydrolysis (Lue and Hsieh, 2010).

FIG. 9. Panco2 cell survival percentage after incubation with different concentrations of the CNCs. The CNCs show no toxicity to mammalian cells which infers the edibility and biocompatibility of the material.

FIG. 10. Histogram of coating thickness. Seven incidence of nanocomposite coating thickness were measured from the confocal image of coated banana skin cross section. The highest frequency of coating thickness is between 15 and 25 μm

FIG. 11. Thickness measurement of YZ direction. Confocal imaging was used to obtain slices of coated banana skin image (surface is XY direction) with varied Z position. The YZ plane of stacked images was converted to grey scale and processed with thresholding, where coating was shown as black. Each line represents a slice of coated banana skin surface and is 5 μm thick. Thus, the coating thickness is calculated to be 15-35 μm (3 slices to 7 slices).

FIG. 12. Compression stress-strain plot of fruits. Force was plotted against the deformation of the fruits. Coated fruits show greater stiffness compared to bare fruits.

FIG. 13. Infrared spectra of poly(albumen) film (EW), poly(albumen)-egg yolk (EW+EY) film, poly(albumen)-egg yolk-glycerol (EW+EY+Gly) film, poly(albumen)-egg yolk-glycerol-curcumin (EW+EY+Gly+Cur) film, and poly(albumen)-egg yolk-glycerol-curcumin-cellulose nanocrystals (EW+EY+Gly+Cur+CNCs) or nanocomposite film.

FIG. 14. Tensile stress-strain plot of films. A representative stress vs. strain response of the coating film. Ultimate tensile strength was approximately 3.4 MPa and ultimate fracture strain was about 13.5%

FIG. 15. Biaxial puncture test setup with an enlarged sample grid and needle.

FIGS. 16A-B. TEM images of nanocomposites at (FIG. 16A) low magnification and (FIG. 16B) high magnification showing the presence of CNCs in poly-albumen matrix.

FIG. 17. Time-lapse photographs of uncoated, chitosan-coated, wax-coated and nanocomposite-coated climacteric fruits (avocado and banana). Coating shows significantly less change in appearance compared to other coatings and uncoated one.

FIG. 18. Weight loss of bare and coated avocado as a function of time after purchase. Nanocomposite-coated fruits exhibit lower weight reductions compared to fruits with other coatings and uncoated fruits.

### DESCRIPTION OF ILLUSTRATIVE EMBODIMENTS

Fruits and vegetables are an integral part of our food, providing us with various nutrients for a complete diet. A major challenge faced by the food industry is that fruits and vegetables are easily perishable with a shelf life of only a few days. The main factors affecting the quality and post-harvest life of fruits and vegetables are water loss, enzymatic browning, texture deterioration, senescence processes and microbial growth, among others. Around 40-50% of harvested produce is lost before consumption every year. Moreover, the common practice of food waxing does not adequately address this significant need in the industry.

A potential sustainable bionanocomposite that has yet to be investigated is egg white or egg albumen and yolks together reinforced with cellulose nanomaterials in increasing the shelf life of perishable produces. It is noted that cellulose, the most abundant biopolymer on earth, has excellent mechanical and gas barrier properties at nanoscale and can be synthesized from waste sources as well (Moon et al., 2011; Kontturi et al., 2018; Almeida et al., 2018). In this study, the inventors developed an edible and washable nanocomposite based on egg white or poly(albumen) and cellulose nanocrystals which can be coated conformally onto different perishable fruits as a micron-thickness coating using different approaches such as dip and spray coating. The coating successfully reduces microbial growth, respiration, and dehydration of fruits all of which contribute to an increased shelf-life while being edible and washable. Strawberries, avocadoes, papayas, and bananas have been utilized to demonstrate the effectiveness of the coating. The coating preserves the cosmetic appearance and shelf life of the fruits for longer and is easily washed off so that the taste for consumers is not altered.

Thus, it is proposed here that an egg-based multifunctional coating is promising as an economical and sustainable method to reduce global food waste by preventing post-harvest losses of perishable foods. The following disclosure describes the development of a poly-albumen polymer based edible film for fruit and vegetable preservatives. The egg yolk serves as an internal plasticizer and the egg white or poly-albumen is crosslinked with cinnamaldehyde, riboflavin or curcumin. Glycerol is employed as an external plasticizer in the film enhancing the flexible nature of the coating. The edible coating possesses antimicrobial and antioxidant properties, which arises from the employment of cinnamaldehyde, riboflavin or curcumin crosslinkers.

These and other aspects of the disclosure are described in detail below.

### I. Vegetable and Fruit Foodstuffs

A. Fruits

In botany, a fruit is the seed-bearing structure in flowering plants that is formed from the ovary after flowering. Fruits are the means by which flowering plants (also known as angiosperms) disseminate their seeds. Edible fruits in particular have long propagated using the movements of humans and animals in a symbiotic relationship that is the means for seed dispersal for the one group and nutrition for the other; in fact, humans and many animals have become dependent on fruits as a source of food. Consequently, fruits account for a substantial fraction of the world's agricultural output, and some (such as the apple and the pomegranate) have acquired extensive cultural and symbolic meanings.

In common language usage, “fruit” normally means the fleshy seed-associated structures (or produce) of plants that typically are sweet or sour and edible in the raw state, such as apples, bananas, grapes, lemons, oranges, and strawberries. In botanical usage, the term “fruit” also includes many structures that are not commonly called “fruits,” such as nuts, bean pods, corn kernels, tomatoes, and wheat grains.

Consistent with the three modes of fruit development plant scientists have classified fruits into three main groups: simple fruits, aggregate fruits, and multiple (or composite) fruits. The groupings reflect how the ovary and other flower organs are arranged and how the fruits develop, but they are not evolutionarily relevant as diverse plant taxa may be in the same group.

B. Vegetables

Vegetables are parts of plants that are consumed by humans or other animals as food. The original meaning is still commonly used and is applied to plants collectively to refer to all edible plant matter, including the flowers, fruits, stems, leaves, roots, and seeds. An alternate definition of the term is applied somewhat arbitrarily, often by culinary and cultural tradition. It may exclude foods derived from some plants that are fruits, flowers, nuts, and cereal grains, but include savoury fruits such as tomatoes and courgettes, flowers such as broccoli, and seeds such as pulses.

The exact definition of “vegetable” may vary simply because of the many parts of a plant consumed as food worldwide—roots, stems, leaves, flowers, fruits, and seeds. The broadest definition is the word's use adjectivally to mean “matter of plant origin.” More specifically, a vegetable may be defined as “any plant, part of which is used for food,” a secondary meaning then being “the edible part of such a plant.” A more precise definition is “any plant part consumed for food that is not a fruit or seed but including mature fruits that are eaten as part of a main meal.” Falling outside these definitions are edible fungi (such as edible mushrooms) and edible seaweed which, although not parts of plants, are often treated as vegetables.

In the latter-mentioned definition of vegetable, which is used in everyday language, the words fruit and vegetable are mutually exclusive. Fruit has a precise botanical meaning, being a part that developed from the ovary of a flowering plant. This is considerably different from the word's culinary meaning. While peaches, plums, and oranges are fruit in both senses, many items commonly called vegetables, such as eggplants, bell peppers, and tomatoes, are botanically fruits.

Vegetables can be eaten either raw or cooked and play an important role in human nutrition, being mostly low in fat and carbohydrates, but high in vitamins, minerals and dietary fiber. Many nutritionists encourage people to consume plenty of fruit and vegetables, five or more portions a day often being recommended.

### II. Coating Materials

A. Egg White and Yolk

Egg white is the clear liquid, also called the albumen, contained within an egg. In chickens it is formed from the layers of secretions of the anterior section of the hen's oviduct during the passage of the egg. It forms around fertilized or unfertilized egg yolks. The primary natural purpose of egg white is to protect the yolk and provide additional nutrition for the growth of the embryo (when fertilized). Egg white consists primarily of about 90% water into which about 10% proteins (including albumins, mucoproteins, and globulins) are dissolved. Unlike the yolk, which is high in lipids (fats), egg white contains almost no fat, and carbohydrate content is less than 1%. Egg whites contain about 56% of the protein in the egg. Egg white has many food applications as well as many other uses (e.g., in the preparation of vaccines such as those for influenza).

Egg white makes up around two-thirds of a chicken egg by weight. Water constitutes about 90% of this, with protein, trace minerals, fatty material, vitamins, and glucose contributing the remainder. A raw U.S. large egg contains around 33 grams of egg white with 3.6 grams of protein, 0.24 grams of carbohydrate and 55 milligrams of sodium. It contains no cholesterol, and the energy content is about 17 calories. Egg white is an alkaline solution and contains around 148 proteins.

Ovalbumin is the most abundant protein in albumen. Classed as phosphoglycoprotein, during storage, it converts into s-ovalbumin (5% at the time of laying) and can reach up to 80% after six months of cold storage. Ovalbumin in solution is heat-resistant. Denaturation temperature is around 84° C., but it can be easily denatured by physical stresses. Conalbumin/ovotransferrin is a glycoprotein which has the capacity to bind the bi- and trivalent metal cations into a complex and is more heat sensitive than ovalbumin. At its isoelectric pH (6.5), it can bind two cations and assume a red or yellow color. These metal complexes are more heat stable than the native state. Ovomucoid is the major allergen from egg white and is a heat-resistant glycoprotein found to be a trypsin inhibitor. Lysozyme is a holoprotein which can lyse the wall of certain Gram-positive bacteria and is found at high levels in the chalaziferous layer and the chalazae which anchor the yolk towards the middle of the egg. Ovomucin is a glycoprotein which may contribute to the gel-like structure of thick albumen. The amount of ovomucin in the thick albumen is four times greater than in the thin albumen.

Egg white can be crosslinked to create poly-albumen. Albumen and poly-albumen are generally considered the same material but the polymeric properties of poly-albumen make it very useful in a variety of chemical and manufacturing endeavors. Methods for preparing poly-albumen from albumen are set forth in the examples. The same material used to crosslink albumen, creating poly-albumen, may act as an anti-oxidant and/or an anti-microbial.

Among animals which produce eggs, the yolk (also known as the vitellus) is the nutrient-bearing portion of the egg whose primary function is to supply food for the development of the embryo. Some types of egg contain no yolk, for example because they are laid in situations where the food supply is sufficient (such as in the body of the host of a parasitoid) or because the embryo develops in the parent's body, which supplies the food, usually through a placenta. Reproductive systems in which the mother's body supplies the embryo directly are said to be matrotrophic; those in which the embryo is supplied by yolk are said to be lecithotrophic. In many species, such as all birds, and most reptiles and insects, the yolk takes the form of a special storage organ constructed in the reproductive tract of the mother. In many other animals, especially very small species such as some fish and invertebrates, the yolk material is not in a special organ, but inside the egg cell (ovum). Yolks are often rich in vitamins, minerals, lipids and proteins. The proteins function partly as food in their own right, and partly in regulating the storage and supply of the other nutrients. For example, in some species the amount of yolk in an egg cell affects the developmental processes that follow fertilization.

As food, the chicken egg yolk is a major source of vitamins and minerals. It contains all of the egg's fat and cholesterol, and nearly half of the protein. Egg yolk contains an antibody called antiglobulin (IgY). The antibody transfers from the laying hen to the egg yolk by passive immunity to protect both embryo and hatchling from microorganism invasion. The yolk makes up about 33% of the liquid weight of the egg; it contains about 60 kilocalories (250 kJ), three times the energy content of the egg white, mostly due to its fat content. All of the fat-soluble vitamins (A, D, E and K) are found in the egg yolk. Egg yolk is one of the few foods naturally containing vitamin D. The composition (by weight) of the most prevalent fatty acids in egg yolk typically is:
Unsaturated fatty acids:
   Oleic acid, 47%
   Linoleic acid, 16%
   Palmitoleic acid, 5%
   Linolenic acid, 2%
Saturated fatty acids:
   Palmitic acid, 23%
   Stearic acid, 4%
   Myristic acid, 1%
      Egg yolk is a source of lecithin, as well as egg oil, for cosmetic and pharmaceutical applications. Based on weight, egg yolk contains about 9% lecithin. The yellow color is due to lutein and zeaxanthin, which are yellow or orange carotenoids known as xanthophylls.

The different yolk proteins have distinct roles. Phosvitins are important in sequestering calcium, iron, and other cations for the developing embryo. Phosvitins are one of the most phosphorylated (10%) proteins in nature; the high concentration of phosphate groups provides efficient metal-binding sites in clusters. Lipovitellins are involved in lipid and metal storage and contain a heterogeneous mixture of about 16% (w/w) noncovalently bound lipid, most being phospholipid. Lipovitellin-1 contains two chains, LV1N and LV1C.

Yolks hold more than 90% of the calcium, iron, phosphorus, zinc, thiamine, vitamin B₆, folate, vitamin B₁₂, and pantothenic acid of the egg. In addition, yolks cover all of the fat-soluble vitamins: A, D, E, and K in the egg, as well as all of the essential fatty acids. A single yolk from a large egg contains roughly 22 mg of calcium, 66 mg of phosphorus, 9.5 micrograms of selenium, and 19 mg of potassium, according to the USDA.

B. Cellulose Nanocrystals

Nanocellulose is a term referring to nano-structured cellulose. This may be either cellulose nanocrystal (CNC or NCC), cellulose nanofibers (CNF) also called nanofibrillated cellulose (NFC), or bacterial nanocellulose, which refers to nano-structured cellulose produced by bacteria. Nanocellulose can be used as a low-calorie replacement for carbohydrate additives used as thickeners, flavor carriers, and suspension stabilizers in a wide variety of food products. It is useful for producing fillings, crushes, chips, wafers, soups, gravies, puddings, etc. The food applications arise from the rheological behavior of the nanocellulose gel.

CNF is a material composed of nanosized cellulose fibrils with a high aspect ratio (length to width ratio). Typical fibril widths are 5-20 nanometers with a wide range of lengths, typically several micrometers. It is pseudo-plastic and exhibits thixotropy, the property of certain gels or fluids that are thick (viscous) under normal conditions but become less viscous when shaken or agitated. When the shearing forces are removed the gel regains much of its original state. The fibrils are isolated from any cellulose containing source including wood-based fibers (pulp fibers) through high-pressure, high temperature and high velocity impact homogenization, grinding or microfluidization (see manufacture below).

Nanocellulose can also be obtained from native fibers by an acid hydrolysis, giving rise to highly crystalline and rigid nanoparticles which are shorter (100 s to 1000 nanometers) than the cellulose nanofibrils (CNF) obtained through homogenization, microfluiodization or grinding routes. The resulting material is known as cellulose nanocrystal (CNC).

The ultrastructure of nanocellulose derived from various sources has been extensively studied. Techniques such as transmission electron microscopy (TEM), scanning electron microscopy (SEM), atomic force microscopy (AFM), wide angle X-ray scattering (WAXS), small incidence angle X-ray diffraction and solid state ¹³C cross-polarization magic angle spinning (CP/MAS), nuclear magnetic resonance (NMR) and spectroscopy have been used to characterize typically dried nanocellulose morphology.

A combination of microscopic techniques with image analysis can provide information on fibril widths, it is more difficult to determine fibril lengths, because of entanglements and difficulties in identifying both ends of individual nanofibrils. Also, nanocellulose suspensions may not be homogeneous and can consist of various structural components, including cellulose nanofibrils and nanofibril bundles.

Crystalline cellulose has a stiffness about 140-220 GPa, comparable with that of Kevlar and better than that of glass fiber, both of which are used commercially to reinforce plastics. Films made from nanocellulose have high strength (over 200 MPa), high stiffness (around 20 GPa) but lack of high strain (12%). Its strength/weight ratio is 8 times that of stainless steel. Fibers made from nanocellulose have high strength (up to 1.57 GPa) and stiffness (up to 86 GPa)

In semi-crystalline polymers, the crystalline regions are considered to be gas impermeable. Due to relatively high crystallinity, in combination with the ability of the nanofibers to form a dense network held together by strong inter-fibrillar bonds (high cohesive energy density), it has been suggested that nanocellulose might act as a barrier material. Although the number of reported oxygen permeability values are limited, reports attribute high oxygen barrier properties to nanocellulose films. One study reported an oxygen permeability of 0.0006 (cm³ μm)/(m² day kPa) for a ca. 5 μm thin nanocellulose film at 23° C. and 0% RH. In a related study, a more than 700-fold decrease in oxygen permeability of a polylactide (PLA) film when a nanocellulose layer was added to the PLA surface was reported.

Changing the surface functionality of the cellulose nanoparticle can affect the permeability of nanocellulose films. Films constituted of negatively charged cellulose nanowhiskers could effectively reduce permeation of negatively charged ions, while leaving neutral ions virtually unaffected. Positively charged ions were found to accumulate in the membrane.

C. Anti-Microbials and Anti-Oxidants

Other materials that can be used in the compositions of this disclosure may also include anti-microbials and/or anti-oxidants such as cinnamaldehyde, riboflavin and curcumin.

Cinnamaldehyde is an organic compound with the formula C₆H₅CH═CHCHO. Occurring naturally as predominantly the trans (E) isomer, it gives cinnamon its flavor and odor. It is a phenylpropanoid that is naturally synthesized by the shikimate pathway. This pale yellow, viscous liquid occurs in the bark of cinnamon trees and other species of the genus Cinnamomum. The essential oil of cinnamon bark is about 90% cinnamaldehyde.

Riboflavin, also known as vitamin B₂, is a vitamin found in food and used as a dietary supplement. It is required by the body for cellular respiration. Food sources include eggs, green vegetables, milk and other dairy products, meat, mushrooms, and almonds. Some countries require its addition to grains. As a supplement, it is used to prevent and treat riboflavin deficiency. At amounts far in excess of what is needed to meet dietary needs as a nutrient, riboflavin may prevent migraines. Riboflavin may be given by mouth or injection. It is nearly always well tolerated. Normal doses are safe during pregnancy.

Curcumin is a bright yellow chemical produced by plants of the Curcuma longa species. It is the principal curcuminoid of turmeric (Curcuma longa), a member of the ginger family, Zingiberaceae. It is sold as an herbal supplement, cosmetics ingredient, food flavoring, and food coloring. Chemically, curcumin is a diarylheptanoid, belonging to the group of curcuminoids, which are natural phenols responsible for turmeric's yellow color. It is a Keto-enol tautomer, existing in enolic form in organic solvents and in keto form in water.

Laboratory and clinical research have not confirmed any medical use for curcumin. It is difficult to study because it is both unstable and poorly bioavailable. It is unlikely to produce useful leads for drug development.

D. Glyceryol

Glycerol (also called glycerine in British English or glycerin in American English) is a simple polyol compound. It is a colorless, odorless, viscous liquid that is sweet-tasting and non-toxic. The glycerol backbone is found in those lipids known as glycerides. Due to having antimicrobial and antiviral properties it is widely used in FDA approved wound and burn treatments. It can be used as an effective marker to measure liver disease. It is also widely used as a sweetener in the food industry and as a humectant in pharmaceutical formulations. Owing to the presence of three hydroxyl groups, glycerol is miscible with water and is hygroscopic in nature. Although achiral, glycerol is prochiral with respect to reactions of one of the two primary alcohols. Thus, in substituted derivatives, the stereospecific numbering labels the molecule with a “sn-” prefix before the stem name of the molecule.

In food and beverages, glycerol serves as a humectant, solvent, and sweetener, and may help preserve foods. It is also used as filler in commercially prepared low-fat foods, and as a thickening agent in liqueurs. Glycerol and water are used to preserve certain types of plant leaves. As a sugar substitute, it has approximately 27 kilocalories per teaspoon (sugar has 20) and is 60% as sweet as sucrose. It does not feed the bacteria that form a dental plaque and cause dental cavities. As a food additive, glycerol is labeled as E number E422. It is added to icing (frosting) to prevent it from setting too hard.

As used in foods, glycerol is categorized by the U.S. Academy of Nutrition and Dietetics as a carbohydrate. The U.S. Food and Drug Administration (FDA) carbohydrate designation includes all caloric macronutrients excluding protein and fat. Glycerol has a caloric density similar to table sugar, but a lower glycemic index and different metabolic pathway within the body, so some dietary advocates accept glycerol as a sweetener compatible with low-carbohydrate diets. It is also recommended as an additive when using polyol sweeteners such as erythritol and xylitol which have a cooling effect, due to its heating effect in the mouth, if the cooling effect is not wanted.

### III. Preparing and Applying Coatings

The food coatings of this disclosure can be made as follows. First, one will dissolve poly-albumen in an aqueous solution and optionally adjust the pH of the dissolved poly-albumen solution to be at or greater than pH 8.0 at a temperature of 50-80° C. Next, an external plasticizer is added, followed by addition of cellulose nanocrystals (CNCs). The poly-albumen may in particular be derived from whole egg or egg white proteins. In some embodiments, an anti-microbial and/or anti-oxidant is added after the external plasticizer but for the CNCs. Additionally, or alternatively, egg yolk protein may be added in this same time as the anti-microbial and/or anti-oxidant.

Once the coating material has been prepared, it will be applied to the food product. Applying may involve dipping, spraying, rinsing, painting or any other form of contacting the surface of the food product. The application and/or subsequent drying of the coasting material can be performed at ambient/room temperature. The application generally will be performed quickly, such as over the course of a few second, or about 0.5 to about 5 seconds. However, there is no particular reason that longer applications times my not be employed, and in some cases may be advantageous. Also, the process may be repeated to produce multiple coats or thicker coatings, such as 2, 3, 4, 5, 6, 7, 8, 9, 10 or more applications.

### IV. Examples

The following examples are included to demonstrate preferred embodiments. It should be appreciated by those of skill in the art that the techniques disclosed in the examples that follow represent techniques discovered by the inventor to function well in the practice of embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1—Materials and Methods

Materials. Egg white powder was purchased from Judee's Gluten Frees. Egg yolk powder was purchased from Modernized Pantry. Analytical grade Sodium Hydroxide pellets were acquired from BDH, and glycerol (99.5%≥purity) was purchased from Sigma-Aldrich. Cellulose nanocrystals (CNC) (˜10.4 wt. %) were obtained from the University of Maine's Product Development Center. Organic curcumin powder with 95% Curcuminoids was purchased from Micro Ingredients.

Synthesis of cellulose nanocrystals. Cellulose nanocrystals (CNCs) are produced from wood pulp at U.S. Forest Service Cellulose Nano-Materials Pilot Plant in the Forest Products Laboratory (FPL) according to the procedure described by Beck-Candanedo et al. (2005). Briefly, CNCs were prepared using ˜64% sulfuric acid by hydrolysis of the amorphous regions in cellulose polymer, which yields the acid resistant crystals as a product. The crystals were purified by dilution and neutralization of the acid, followed by separation of the soluble components such as glucose and salt byproducts from the insoluble CNC using a vacuum filtration technique. Two stages of dilution and settling were conducted to remove most of the soluble components (˜90%). Once the ionic strength was low enough, the sulfonic acid groups on the CNCs provided a stable suspension and continuous dilution and filtration was used to remove the remaining soluble contents. The final stage was to remove water using the membrane filtration system, resulting in a 5-6.5% aqueous viscous slurry. It is noted that there was sufficiently low water content and high enough ionic strength from acid groups on the CNCs to limit bacterial or fungal growth in the stable slurry. The CNCs suspension was stored at ˜4° C. before use in the nanocomposites.

Synthesis of coating solution. The nanocomposite fruit coatings were prepared by dip-coating fruit into the nanocomposite solution. The solution was synthesized by first, egg white powder was dispersed into DI water 1:15 (w/v) by a magnetic stirrer for 15 min. After the mixture was homogenized, the pH of the solution was adjusted to 10 by adding NaOH pellets. Then, glycerol (30 wt. % of egg white powder) was added, and the solution was stirred for 15 min at 80° C. Egg yolk powder (15 wt. % of egg white powder) pre-dispersed in DI water was added into the solution and stirred for 5 min at the same temperature. Subsequently, curcumin powder (5 wt. % of egg white powder) dispersed into DI water was incorporated then stirred for another 5 min. Lastly, cellulose nanocrystals (30 wt. % egg white powder) was dispersed in the solution for about 5 min. The mixture was cooled at room temperature for 30 min. To produce the nanocomposite coating film, the solution was poured onto the Teflon sheet and air-dried at RT for 2˜3 consecutive days.

Preparation of Fruit Coating. After cooling, the nanocomposite solution is capable of dip or spray-coating onto fruits. In this study, the inventors chose the dip-coating method to coat fruits. Four different fruits (strawberries, bananas, papayas, and avocados) were soaked completely into the solution by holding the stem. After drying for 1 min through hanging on a rack with the stem tied by a string, the fruit was coated with a second layer then dried in the same way at room temperature.

Transmission electron microscopy (TEM). TEM micrographs were obtained using transmission electron microscope (Philips CM-100) with an acceleration voltage of 100 kV to analyze the size and shape of cellulose nanocrystals (CNCs). A drop of diluted dispersion of CNCs was deposited on carbon-coated grid and dried prior to observations. Image J software was used to measure the length and diameter of CNCs.

To understand the dispersion of CNCs in the nanocomposite coating, the nanocomposite film was treated overnight in 3% ethanolic glutaraldehyde, rinsed with fresh ethanol, then sections on 100 nm thickness were cut using an ultramicrotome. Sections were stained with 1% osmium tetroxide, post-stained with 3% uranyl acetate and 3% lead citrate, then rinsed and dried. TEM images were collected with a JEOL JEM-1230 at 80 kV.

Atomic force microscopy (AFM). Atomic force microscopy (AFM) images of CNCs and nanocomposite films were obtained in tapping mode using a Park NX-10 microscope. The measurements were carried out in air using silicon nitride cantilevers at room temperature. The procedure used for imaging the CNCs were similar to the procedures reported by Brinkmann et al. (2016). Briefly, freshly cleaved mica (1 in.×1 in.) was incubated in ˜200 μL of a ˜0.01 wt. % poly-L-lysine solution for ˜30 min and then the mica was rinsed five times with DI water and dried in a nitrogen stream. About 80 μL of a de-ionized (DI) water diluted suspension of CNCs (1:10000) was deposited onto the substrate and incubated for ˜1.5 min. The samples were then washed with DI water and dried once again with the nitrogen stream.

AFM images of nanocomposite films were recorded with a scan size of 25 μm×25 μm. The root-mean-square roughness (R_{q}) was evaluated over the scanning area as the standard deviation of the topography (M pixels N pixels).

Zeta (ζ) potential. Zeta (ζ) potentials of cellulose nanocrystal aqueous dispersions were measured at ambient temperature using Malvern Zetasizer Nano ZS90 according to the Smoluchowski's equation to understand the dispersion stability (Sze et al, 2003). Suspension was prepared by dispersing CNC in DI water using ultrasonication for 30 s at 25% intensity.

X-ray diffraction (XRD). XRD patterns of CNC films were recorded on an X-ray diffractometer (Panalytical Empyrean powder X-ray diffractometer) equipped with Cu Kα1 radiation (λ=0.154 nm) at 45 kV and 40 mA. Data were collected from 5° to 40° Bragg angles (2θ) at a scan rate of 2 deg/min and a step interval of 0.02°. The CNC film was prepared by using 24 g (˜5 wt. %) CNC suspension was placed into a polystyrene petri dish and sample was dried at room temperature for 72 h. The Peaks from XRD were identified and deconvoluted using Origin Pro software to calculate crystallinity index. The crystallinity index was calculated from the (200) plane of cellulose Iβ, using Segal equation:

$$Crystallinity index ( \% ) = \frac{{I}_{I β ( 200 )} - {I}_{I β Amorphous}}{{I}_{I β ( 200 )}} , \qquad ( 200 )$$

where I is the intensity of the deconvoluted peak at the plane's characteristic angle.

Fourier-transform infrared spectroscopy (FTIR). The chemical structures of CNCs and different films were investigated by ATR-FTIR (Spectrum 100, PerkinElmer, Waltham, Mass., USA). The scan range was 4000 to 600 cm⁻¹ with resolution of 4 cm⁻¹.

Rheology and Contact Angle Measurement. Viscosity data was collected using an ARES G2 rheometer with a 25 mm cone and plate geometry with a 0.1-radian cone angle. The nanocomposite's viscosity was measured at ambient conditions using a flow experiment at shear rates ranging from 10⁻² to 10² sec⁻¹. A force tensiometer (K100, Kruss Instruments) was used to obtain the surface tension of the nanocomposite solution. Contact angle measurements of water on the dried nanocomposite film and the nanocomposite solution on papaya, avocado, and banana were preformed using a Drop Shape Analyzer (DSA 100, Kruss Instruments) at ambient conditions.

Confocal Microscopy. Coated and bare bananas were diced using fruit dicer. The diced peels were imaged at two different orientations, (i) to acquire images of the outer skin surface (top), the diced peel sample was placed with the inner skin (adjoining the banana pulp) facing down on the glass slide, and (ii) to acquire images of both the outer surface and inner face of the peel, i.e., along the depth of the peel, the diced samples were laid on their side (inverted) on the glass slide. Images were simultaneously acquired at three different excitation wavelengths 405, 488, and 594 nm using the FluoView-1000 confocal microscope (Olympus America, NY). Images were processed using background subtraction. A total of 30 thickness measurements were made using six single optical images (5 measurements per image) and OLYMPUS FLUOVIEW Ver.4.2.b software. Thickness measurements were confirmed via YZ projections, using Image J.

Mechanical properties. The tensile properties of the nanocomposite films were measured by dynamic mechanical analysis (Q800, TA Instrument, USA). The test was conducted at the ambient conditions with 5 N/min in controlled force rate mode. The length of the films was 30 mm with a gauge length of 10 mm. The thickness and width of the film is around 0.2 mm and 5 mm; hence the cross-sectional area is about 1 mm². At least 5 samples were tested to ensure the consistency of the data.

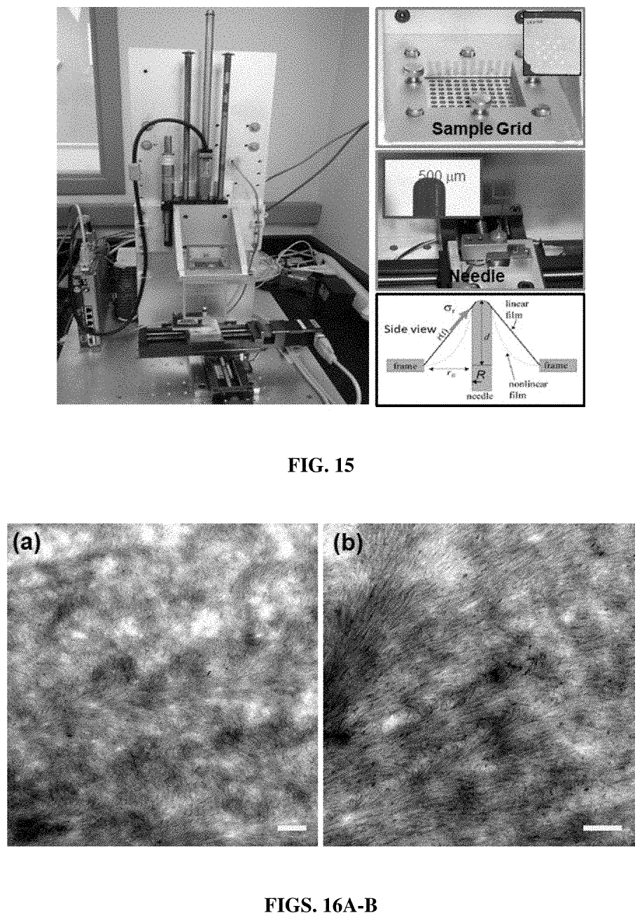

Biaxial tensile testing was performed using a high-throughput mechanical characterization (HTMECH) instrument (Sormana & Chattopadhyay, 2005) (FIG. 15), which measures a combination of bending at early strain and tensile response at high strain. The test measures tensile properties up to failure by bending a film that is fixed around its perimeter by a moving shaft oriented normal to the film. Force vs. displacement data was collected until the breakage of the films. The speed of the 1.25 mm hemispherical indenter was 10 mm/s and 5 different locations were tested on each film. The ultimate tensile strength (UTS) as the maximum stress and strain at break were reported from six stress-strain curves per sample.

Uniaxial compressive tests on the bare and coated fruits were done at room temperature with a standard universal testing machine (Instron 4505, USA) equipped by 100 kN load cell. Samples were placed between two crossheads and checked to avoid misalignment or detachment, then compressed with a constant rate of 2 mm-s⁻¹. The load was measured by load cell while the displacement of crosshead was recorded. The load-displacement data was scanned and recorded on the computer. At least 5 samples were tested to ensure the consistency of the data.

Weight Loss Measurement. Weight loss data were calculated from the measured initially purchased weight (Wₒ) and the weight at subsequent days after purchase (Wₜ). The weight loss value as a function of time was calculated using the equation:

$$Weight loss ( \% ) = ( 1 - \frac{{w}_{t}}{{w}_{0}} ) \times 100.$$

Water vapor permeance. The steady-state water vapor permeability for a free-standing was measured according to ASTM-D1653 by a conventional permeability cup (purchased from Gardco, Fla.). Circular 10 mm diameter samples were precisely cut with a laser cutter and used as test specimens. The permeability cup was filled with anhydrous CaCl₂ and sealed, leaving a small air gap between the specimen and desiccant. The whole arrangement was kept in a desiccator with water and maintained at 23±1° C. with very high (97±1%) relative humidity for this experiment. The increase in cup weight was measured by a microbalance for several days, and the WVTR values were calculated from the slope of the weight change versus time.

Oxygen Permeability. The oxygen permeability (OP) of films was obtained by using a MOCON OXTRAN 1/50 instrument at 50% RH and 23° C. The films were humidified for 1 min using an Electrotech ultrasonic humidification system (Glenside, Pa.) operating at 100% RH for easier handling. The films were cut into squares of approximately 10 cm×10 cm. The test cell for the MOCON measures over a 50 cm² area of the film. The criteria for steady state was that the contiguous readings must differ by less than 1% or 0.05 cc/m²/day (convergence by cycles mode).

Cellular toxicity. Panc02 cells were cocultured with the coating solution, and viability was calculated after 24 h. The cells were cultured in DMEM solution with 10% fetal bovine serum and 1% penicillin-streptomycin and maintained in a 37° C., humidified atmosphere with 5% CO₂. Cell viability was measured using a Promega MTS assay kit. 2500 cells were seeded in 96 well plates and incubated for 24 h before adding fresh solution mixed with different concentrations of [symbol] [symbol] coating solutions (0, 0.01, 0.1, 1.0 μg/mL). After 48 h, the MTS assay was performed. The cell solution was removed from each well, and 100 μL of fresh cell solution was added to each well followed by 20 μl of MTS solution. Cells were incubated at 37° C. for 4 h before reading the optical absorbance at 490 nm. Similar study has been conducted on with different concentrations of CNCs (0, 0.001, 0.1, 1, 10, 20 mg/ml) to investigate the biocompatibility and toxicity of CNCs.

Antimicrobial activity. Polymer specimens were tested for antimicrobial activity using a modified version of protocol ISO 22196. Soybean casein digest broth with lecithin and polyoxyethylene sorbitan monooleate (SCDLP broth) and Mueller-Hinton broth were prepared as previously described. Bacterial pre-culture was prepared from Escherichia coli (E. coli) strain BL21 cells. Polymer specimens were prepared by cutting portions measuring 26 mm×50 mm. As specimens reacted when exposed to solvents, they were sterilized before treatment by exposure to ultraviolet light while within a sterile petri dish. Samples were exposed to a Sterilamp G36T6L lamp with a power of 41 W for 30 min; samples were then flipped using sterile tweezers, and the other side of the sample was exposed for an additional 30 min. Samples were similarly prepared from Parafilm, an inert material, to serve as a control. Tested samples were treated with 200 μL aliquots of diluted bacterial culture and covered with a sterile coverslip measuring 24 mm×40 mm.

Sol-gel Analysis. Pre-weighed amounts of film specimens were immersed in a glass bottle and placed on a platform shaker until it dissolved. The contents of the bottle were filtered using a microfiber-based fabric filter and the gel residue was collected.

### Example 2—Results

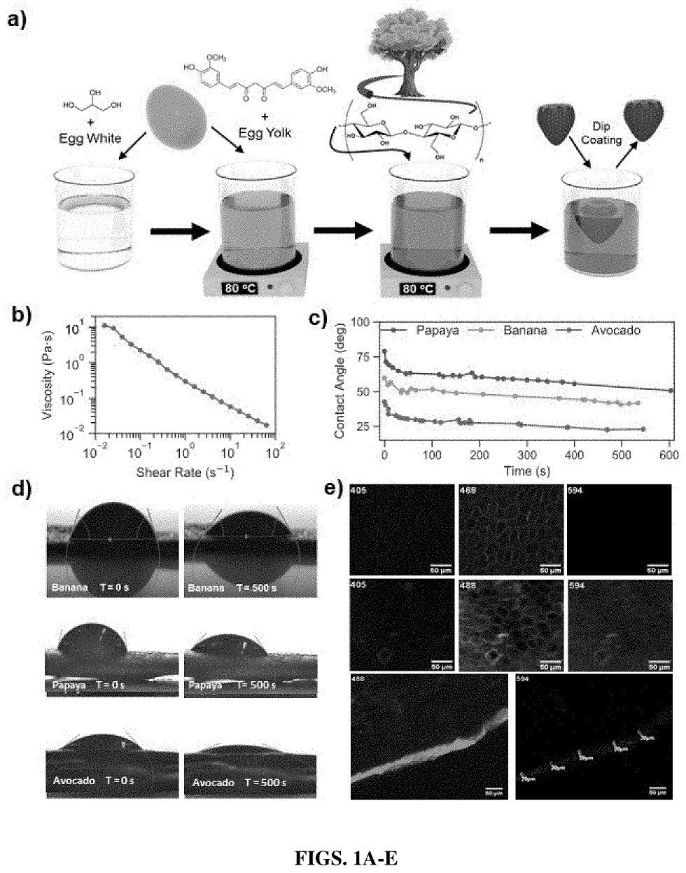

The inventors developed the cellulose nanocrystal reinforced poly(albumen) coating with various biocompatible modifiers to extend both the shelf-life and cosmetic appearance of fruits (Table S1, Example 1). To synthesize the nanocomposite coating, the inventors start with egg whites which are comprised mostly of albumen protein (˜54%) and enable the dried formation of strong edible films with a moderate gas barrier property. However, poly(albumen) is very brittle owing to its random organization of denatured proteins. The addition of plasticizers, such as glycerol, reduces intermolecular forces in the protein chain and increases mobility in the protein-polymer chains and its flexibility (Mekonnen et al., 2013; Rahman & Netravali, 2014). Therefore, an egg white plasticized with glycerol is capable of coating irregularly shaped objects like fruit without cracking. However, glycerol is hydrophilic and swells in humid environments. To prevent unwanted swelling, the inventors incorporated a small fraction of egg yolk, which is hydrophobic and rich in fatty acids and can alleviate the susceptibility to moisture. Next, they added curcumin which is an edible extract from turmeric that possesses antibacterial, antifungal and antibiofilm properties (Liu & Guo, 2018; Wu et al., 2018). These properties reduce microbial growth on the fruit surface while also decreasing 02 and increasing CO₂ in the microenvironment which helps to maintain the fruit's freshness. Lastly, the inventors incorporate cellulose nanocrystals (CNCs) to decrease the water and gas permeance of the coating and to add mechanical reinforcement. CNCs is one of the main components in the preparation of the nanocomposites and synthesized via acid hydrolysis process using wood pulp (detail is provided in supplementary information). The inventors have reported in-depth characterization of the CNCs using transmission electron microscopy (TEM), atomic force microscopy (AFM), zeta potential, x-ray diffraction (XRD), and fourier-transform infrared spectroscopy (FTIR) studies (FIGS. 15-19, Tables S2-S4, Example 1). The inventors' CNCs are well-dispersed in water and possess an aspect ratio of about 18 with an average length and diameter of 110.0±20.0 nm and 6.0±2.0 nm, respectively. The crystallinity index of the CNCs is around 84% as calculated from the deconvoluted XRD peaks. The inventors also have conducted cytotoxicity studies of the CNCs to confirm the safety as food products (FIG. 9). MTS assay showed a complete viability of cells in the presence of the CNCs across a wide range concentration from 0.001 to 20 mg/ml. Thus, the inventors design the nanocomposite coating that can be dip-coated onto a variety of fruit to preserve the freshness of fruits and addresses the common issues responsible for perishability (FIG. 1A).

First, the inventors measured the viscosity of the nanocomposite solution at room temperature as a function of shear rate to investigate the solution's processibility as a conformal coating. The coating solution exhibits shear-thinning behavior and the measured viscosity at a low shear rate (resting state) is around 200 Pa-s (FIG. 1B) which is comparable to 0.25% chitosan solution, considered as another promising food packaging material (Hwang and Shin, 2000). However, unlike the chitosan solution, the inventors' composite solution's viscosity decreases by nearly three orders of magnitude upon shearing. This suggests that spray coating could also be a viable coating method since the high shear rate at the nozzle could reduce the viscosity of the fluid and allow for a thinner and more even coating on the fruit surface.

The inventors measured the affinity of the nanocomposite solution to fruits through contact angle measurement. It is important to understand the wetting of the coating solution on the fruit and its hydrophilicity to determine how the solution forms a uniform surface coating. First, they compared the contact angle of the freshly made coating solution on banana, papaya, and avocado peel. The contact angle on the avocado surface immediately after wetting with a drop was ˜45° and then decreased to ˜25° within 8 min (FIG. 1C). This suggests that the coating has a high affinity to spread onto the avocado surface. Similarly, the initial contact angles between the coating-papaya and coating-banana interfaces are ˜80° and 60°, respectively, and decreased by more than 15% in 8 min. The inventors observed that all the fruit surfaces are suitable for this solution spreading onto the surface. Noticeably, the initial contact angle is the smallest for the avocado and largest for the papaya. This implies that avocado has better wettability than banana, and both have more wettability than the papaya (FIG. 1D). This likely is a result of the papaya's waxy hydrophobic surface. They determined the surface tension of the nanocomposite solution at ambient conditions to calculate the work of adhesion (Wₐ) and spreading coefficient (Wₛ) of the coating on different fruit surfaces using equations: Wₐ=γ₁(1+cos θ) and Wₛ=γ₁ (cos θ−1), where γ₁ is the liquid-solid surface tension, and θ is the contact angle. From the calculation (Table 1), the inventors conclude that the coating can be achieved across all fruit models (with small shear manually in case of papaya) despite the negative spreading coefficient, with the highest adhesion and spreadability to the avocado. As they confirmed, even and uniform coating of the solution via confocal microscopy and the coating is achieved in a non-equilibrium state because the solution dries onto the surfaces of the fruit before it can dewet.

TABLE 1
Work of adhesion and spreading coefficient
of the coating onto the fruits

| Surface Tension | | Contact | Work of | Spreading |
|---|---|---|---|---|
| of solution | Fruit | angle | adhesion | coefficient |
| (mN/m) | model | (°) | (mN/m) | (mN/m) |
| 51.1 | Avocado | 42.8 | 88.5 | −13.6 |
| | Banana | 59.8 | 76.7 | −25.4 |
| | Papaya | 78.9 | 60.9 | −41.3 |

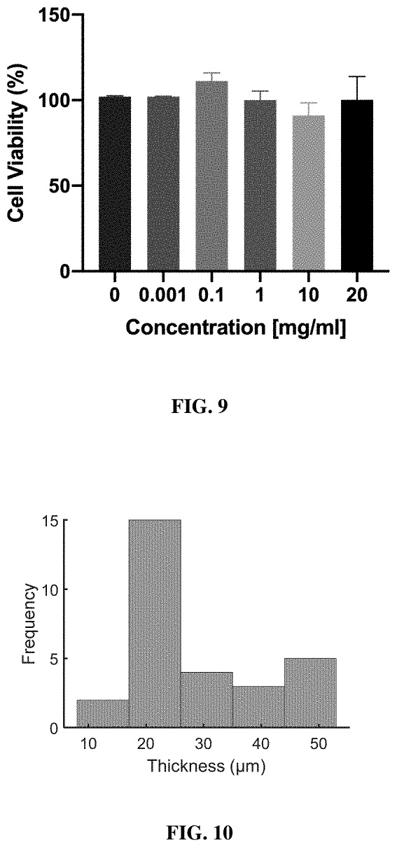

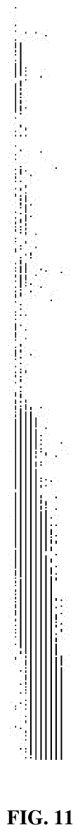

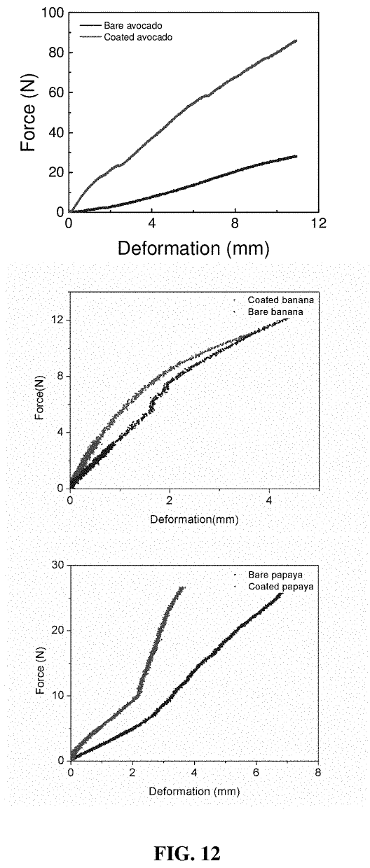

To investigate the thickness and topology of the coating on fresh fruits, the inventors applied laser scanning fluorescence confocal microscopy. Banana fruit was used as a representative since its thicker peel allowed for ease of sample preparation for imaging. Multiple excitation wavelengths (405 nm, 488 nm, and 594 nm) were initially utilized to determine autofluorescence characteristics of uncoated and coated fruit skin. FIG. 1E shows images of the uncoated outer surface layer (top) of the banana peel acquired with the banana peel laid on the glass side with the inner layer of the peel facing down on the slide. The characteristic cell-wall morphology of the outer surface layer of the banana peel is evident in the autofluorescence observed in the blue and green channels, and no fluorescence is observed in the red channel. These results conform with previously published studies, which have demonstrated that the yellow banana peel exhibits blue-green autofluorescence and red fluorescence characteristic of chlorophyll presence is observed in unripened green banana peels (Moser et al., 2008; 2009). Similarly, when imaging the uncoated sample on its side to capture the depth of the peel from the outer surface to the inner layer of the peel, the cell-wall autofluorescence is seen in green, and no fluorescence signal is observed in the red channel. Additionally, the characteristic pattern of rows of adjoining cell-walls observed in images conforms to those observed by Tiessen (2018). Interestingly, following treatment of the yellow banana peel with thin (FIG. 1E) layers of coating, in addition to the banana peel autofluorescence, the coating is seen to autofluorescence in the green and red channels strongly and distinctly. To evaluate the thickness of the coating layer adsorbed onto the fruit the inventors analyzed the coated samples. Moreover, to avoid any overlap between the green autofluorescence of the outer surface layer of the peel and the green fluorescence of the coating, the performed quantitative measurements of coating thickness using the red channel (FIG. 1E). Single optical section images of z-stacks were visually enhanced, and thickness measurements were performed using a built-in measurement tool (OLYMPUS FLUOVIEW Ver.4.2.b Viewer). A histogram of the thickness measurements (FIG. 10, Example 1) showed an average thickness ranged from 23˜33 μm with a 95% confidence interval, comparable to previously reported silk fibroin biopolymer coating for fruit preservation (Marelli et al., 2016). Thickness measurements were confirmed via YZ projections (FIG. 11, Example 1) using Image J. Each black line represents a slice of the image in the red channel showing the presence of the coating. Since each image slice was acquired at a z-interval of 5 μm, the thickness of the coating was calculated to range from 15˜35 μm, with an average thickness of ˜25 μm.

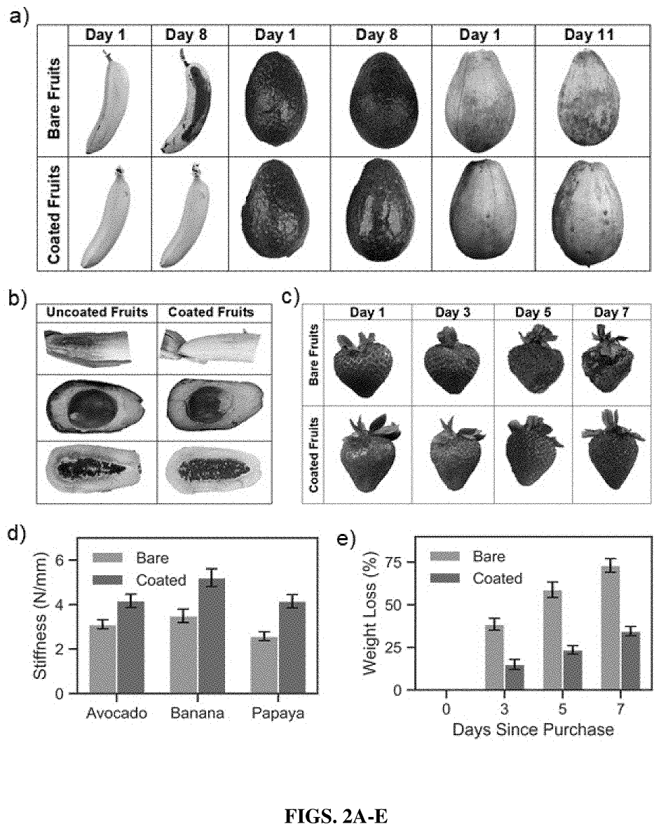

The inventors evaluated the effectiveness of the coating in preserving fruit freshness in four readily available and representative fruits, including three climacteric fruits (banana, avocado, and papaya) and one non-climacteric fruit (strawberry). After 8-11 days post purchase, the uncoated climateric fruits all showed enzymatic browning and decaying on the exterior while the coated fruits retained the appearance for over a week (FIG. 2A). Similarly, interior of the fruits in the coated samples showed less ripening than the uncoated samples (FIG. 2B). The coating's freshness retention was also shown in the non-climacteric fruit (FIG. 2C). After seven days, coated strawberries showed a better appearance, and more weight retainment compared to the uncoated strawberries. Moreover, while the weight of bare strawberries dropped by about 60% on the fifth-day post-purchase at room temperature, the coated strawberries retained more than 65% of the original weight after one week (FIG. 2E). Given the longevity of the coated strawberries, papaya, banana, and avocado compared to their bare counterparts the inventors demonstrate that the coating achieves the goal of preserving the freshness of perishable fruits.

The inventors next compared the firmness and compressibility between coated and uncoated fruits 7-9 days after the fruits are received and treated. As fruits over-ripen or perish, they become softer; therefore, these tests serve to provide further evidence that the coated fruits maintain their freshness longer than bare fruits. The fruit deformation in response to a compression force was recorded and graphed for a banana, avocado, and papaya (FIG. S8, Example 1). The stiffness, k, of the coated and uncoated fruit was extracted from the force vs. deformation data in the initial elastic region using the formula: F=k*x, where, F denotes the compression force applied, and x denotes the deformation of the fruit. In all fruit models, the coated sample had significantly higher stiffness than the uncoated sample and therefore indicated higher firmness (FIG. 2D). The inventors attribute the higher firmness of the coated fruit to more water retainment in the plant cells resulting in higher cellular elasticity. As fruit firmness is indicative of fruit ripeness, these results further confirm that the coating slows the fruit ripening process.

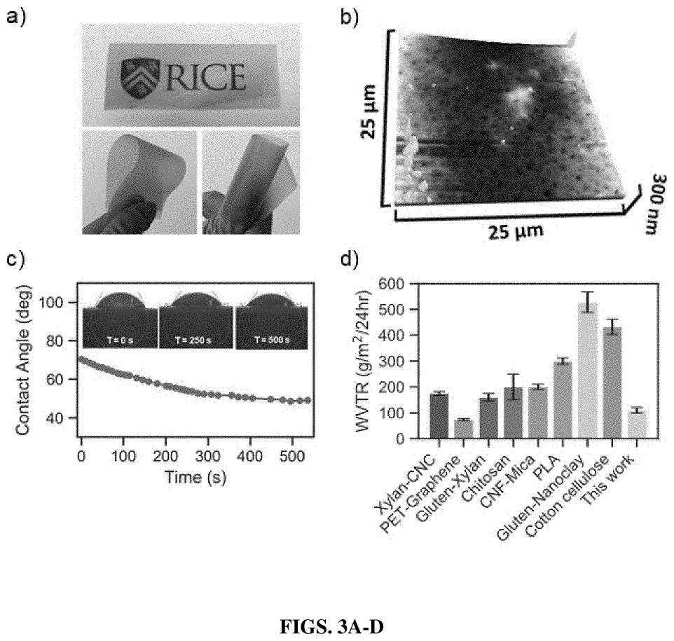

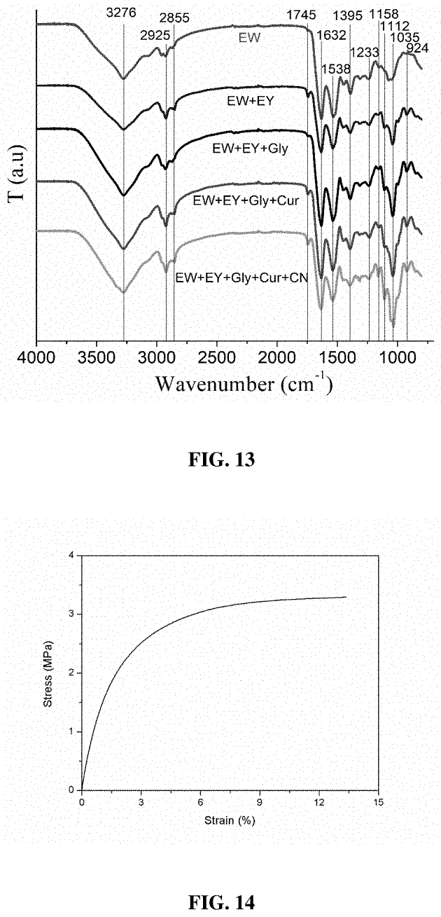

To understand the mechanisms of the nanocomposite coating in preserving fruit freshness, the inventors prepared a free-standing nanocomposite film to perform tests on. Films with ˜70 μm thickness were obtained by solution casting into a Teflon sheet and solvent evaporation (FIG. 3A) at room temperature. The inventors have analyzed IR spectra of the nanocomposites to understand the chemical interactions among the components (FIG. 13, Example 1). The three protein characteristic peaks at 1626, 1538 and 1233 cm⁻¹ are associated with carboxyl (C═O stretching), amide II (N—H bending), and amide III (C—N and N—H stretching) linkages, respectively. The peak around 1745 cm⁻¹ represents the C═O functional group due to the presence of fatty acid in egg yolk (Rahman & Netravali, 2016). The peak at 1035 cm⁻¹ in the final nanocomposites is more prominent which is due to stretching C—O from cellulose I and cellulose II components. The peak around 1155 cm⁻¹ associated with C—O—H groups in poly(albumen), moved to higher stretching frequencies of 1160 cm⁻¹ with significantly enhanced intensity across different composition, signifying increased interactions involving the —OH groups among the components of the films. Also, the peak at 1112 cm⁻¹, which is more prominent in the nanocomposite, indicated the presence of secondary hydroxyl groups (out of phase C—C—O stretch).

The film is extremely flexible as it can be repeatably bent and folded without breaking. Good mechanical properties are among the basic requirements for the film to be used as fruit coating to resist premature failure or cracking during handling and storage. To measure the mechanical performances of the film, the inventors conducted uniaxial and biaxial tensile testing (FIG. 14, Example 1). From the uniaxial tensile testing, the ultimate strength, fracture strain, and toughness or energy-to-break of the film were found to be around 3.4 MPa, 14%, and 37.1 MJ/m³, respectively. Biaxial tensile testing (a combination of bending at early strain and tensile response at high strain) was performed using a high-throughput mechanical characterization (HTMECH) instrument that measures tensile properties up to failure by bending a film that is fixed around its perimeter by a moving shaft oriented normal to the film (detail is available in FIG. 15, Table S4, Example 1). The breaking strength and strain from the test were around 3.4 MPa and 28%, respectively. Such values are comparable to those of most edible films and some of the synthetic plastic films used in fruit packaging such as pectin, starch, protein isolate, chitosan, carnauba wax, low-density polyethylene, and ethylene-vinyl alcohol copolymer, etc. (Table S5, Supplementary Information). The values show that the dried coating is a flexible and mechanically tough material which suits its purpose for thin conformal coating on different shapes of fruits.

Next, AFM images were used to investigate the topography of the dried film (FIG. 3B). The root-mean-square surface roughness was around 12 nm. Hence, the coating is shown to be smooth and homogenous since the roughness was varied in the nanometer-scale ranges. The presence of uniformly distributed CNCs in the nanocomposites is confirmed by a fur-like pattern as observed in TEM micrographs (FIGS. 16A-B, Example 1). Then, the inventors measured the wettability of the coating through contact angle measurement since it is important to understand the hydrophilicity to evaluate its durability as a surface coating. The contact angle of a sessile water droplet on the nanocomposite film immediately after being wetting by a drop (θ_{R0s}) was around 71.4° (FIG. 3C), which is comparable to chitosan films (76°) (Moser et al., 2009). This coating film is categorized as a hydrophilic material (θ_{R0s}<90°), which is further validated by the decreasing contact angle on the water-coating film interface with time. The significant decrease in contact angle from 71.4° to 54.1° corresponds with the time-dependency observed in various polymer surfaces that could be attributed to surface reconstruction due to water absorption into the film^{{23}}. Nevertheless, this coating material is more hydrophobic compared to some other polymers used for packaging like PET (θ_{R0s}˜52°), pullulan (θ_{R0s}˜30°), gelatin (θ_{R0s}˜65°), pectin DE27 DA20 (θ_{R0s}˜58°) and pectin DE72 (θ_{R0s}˜54°) (Farris et al., 2011). This higher hydrophobicity likely contributes to the film's low water permeance, since less intermolecular interaction between water molecules and the hydrophobic pore walls creates less capillary infiltration force for the molecules, which decreases water diffusion through the coating.

To understand the coatings' ability to prevent decay and dehumidification, the inventors measured the water vapor transmission rate through a 100-μm thick dried nanocomposite film at ambient conditions. The coating has a water vapor transmission rate of ˜15 g-mm/m^{g}-day, which is low when compared to other common biopolymers for packaging, including chitosan, polylactic acid (PLA), pectin, protein isolate, and starch-based composites (FIG. 3D) (Plackett, 2011). This low transmission rate suggests that the coating provides a water vapor barrier for the fruit so that moisture is more effectively retained in the fruit. This explains the inventors' previously mentioned results where the weight loss of the coated fruits is significantly lower than that of the bare fruits.

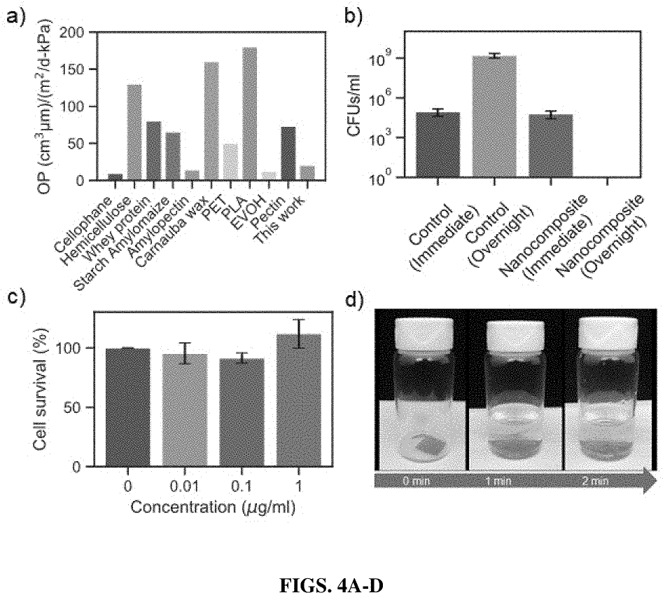

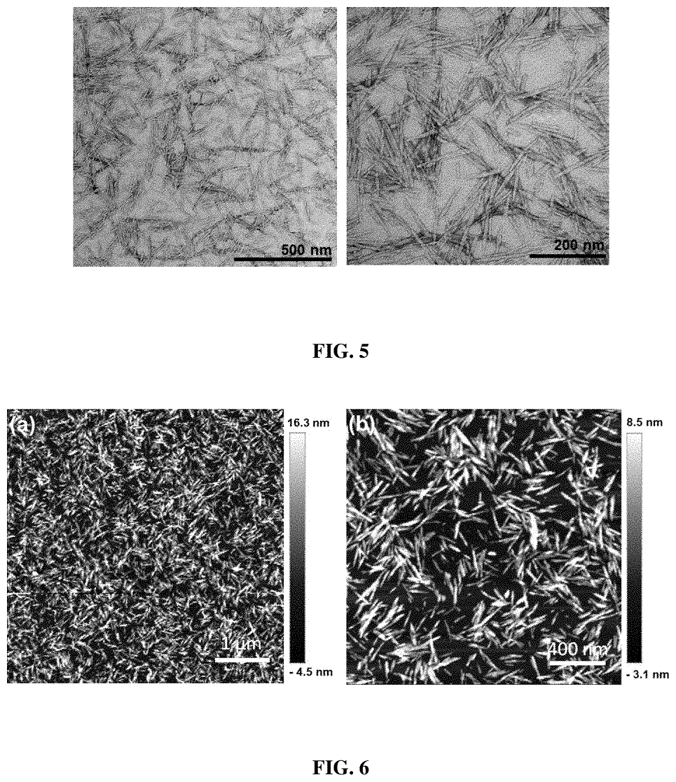

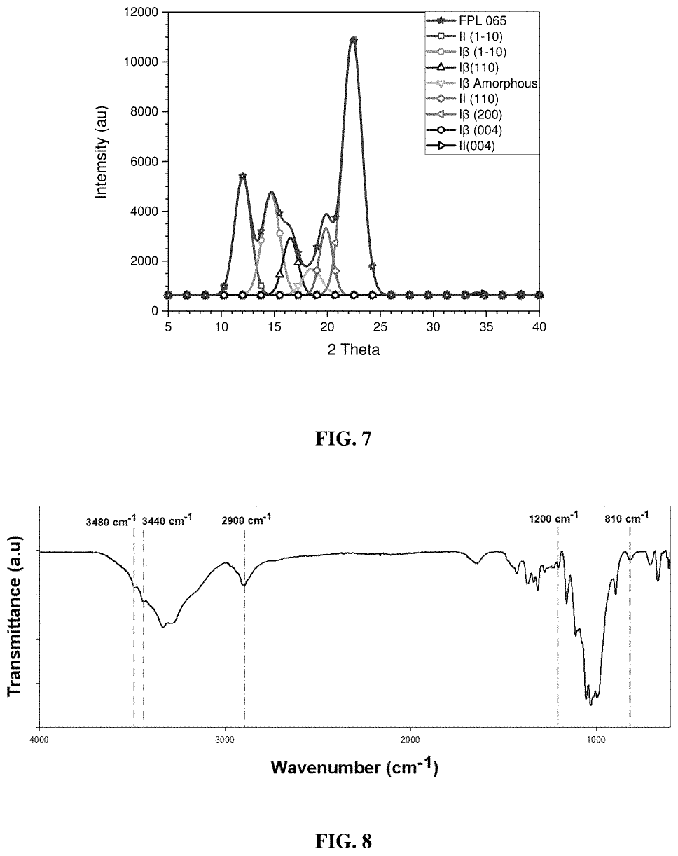

Another important parameter that affects fruit perishability is oxidation as it involves fruit respiration. The inventors measured the O₂ gas barrier properties of the nanocomposite film to understand if the coating's effectiveness against ripening is in part due to its effect on oxidation. They found that the films have a low oxygen permeability (OP) compared to other packaging materials like PLA, carnauba wax, protein isolate, and starch (FIG. 4A) (Plackett, 2011). The 70 μm thick film has an OP of ˜20 cm³-μm/m²-day-kPa at ˜23° C., atmospheric pressure, and ˜50% humidity. This also partially explains the film's effectiveness at delaying fruit ripening because lower oxygen levels in the microenvironment between coating and fruit reduce cellular respiration and slow down the ripening process.

The inventors evaluated the antimicrobial properties of the coating using an E. coli strain as microbial growth is known to contribute to fruit perishability. While instant exposure to the coating film does not decrease bacteria titers, overnight incubation on the film resulted in zero bacteria titers (FIG. 4B). This suggests that the film is effective in eliminating bacteria growth on the surface in less than 24 h, especially when compared to the parafilm control which showed over 10⁴ times higher concentration of colony-forming bacteria. The robust antimicrobial activity of the film could additionally reduce the soft rotting of fresh produce and strengthen the safety of consumption. This would reduce microorganism spoilage which devastates fresh fruit and vegetables after harvest and might even reduce foodborne illness outbreaks. The inventors attribute the antimicrobial property of the coating to the curcumin additive, in which the curcuminoid chemical has demonstrated inhibitory activity against 24 pathogenic bacteria.

Next, the inventors evaluated the toxicity of the coating using in vitro studies with a human pancreatic cancer cell line (Panc02) to evaluate the edibility. Biocompatibility is crucial for the coating to be applied to fruit as consumers could intentionally or accidentally ingest the coating during the consumption of the fruit. After 24 h incubation with 0.1 μg/ml to 1 μg/ml coating, there is no significant change in Panc02 cell (FIG. 4C). In each concentration of the coating, over 90% of the cells stayed alive, which suggests that the nanocomposite solution is not cytotoxic and thus reduces food safety concerns when used for fruit coating. The result is expected as all the components from the coating (egg white protein, cellulose nanocrystal, egg yolk, curcumin, and glycerol) are all present and safe in existing foods.

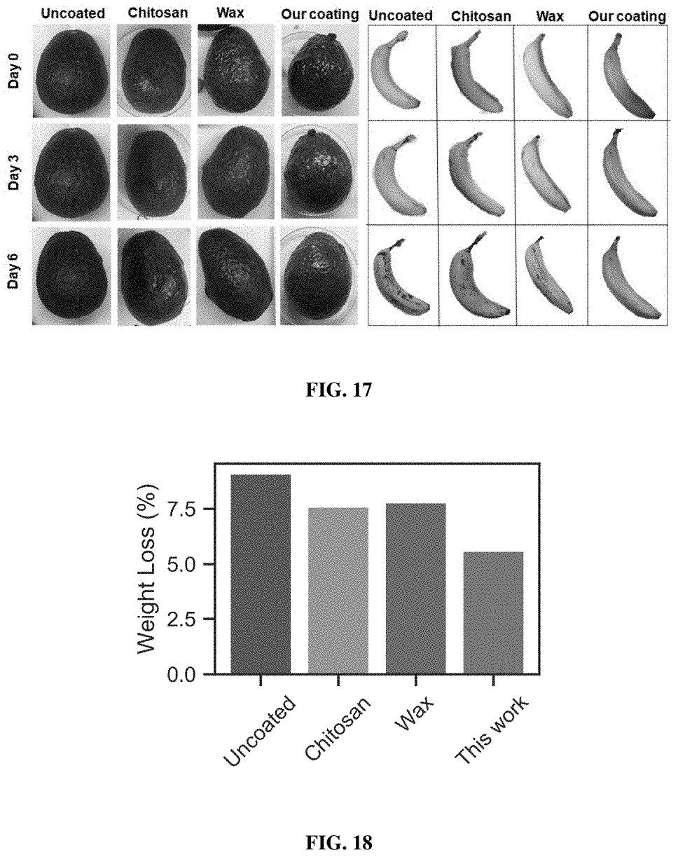

Further qualitative and quantitative comparison studies on two model fruits (avocado and banana) has been conducted using some common edible coating materials to understand the effectiveness of the inventors' nanocomposites (Example 1). The model fruits were avocado and banana. The inventors have selected wax and chitosan based edible coatings to compare with their nanocomposite coating. In terms of visual appearance (FIG. 17), there are clear qualitative differences in the uncoated and various coated samples when compared to the nanocomposite coating, which gives the best appearance. In addition to the above qualitative comparison, the inventors have calculated the weight loss of avocado over 7 days to get a quantitative representation for the various coatings. Weight loss data were calculated from the measured initially purchased weight (W₀) and the weight at 7^{th} day after purchase (W₇). The weight loss value as a function of time was calculated using the equation: Weight loss (%)=(1−W₇/W₀)*100. After seven days, avocado with the inventors' coating showed a better appearance, and more weight retainment (or less weight loss) compared to the uncoated avocado and avocadoes with other coatings (FIG. 18). While the weight loss of bare avocado was around 10% on the seventh-day post-purchase at room temperature, the coated-avocado retained around 95% of the original weight after one week. The weight loss of avocado after 7^{th} day for chitosan and wax coatings were higher than that of the inventors' nanocomposite coating. In terms of visual appearance, there are clear qualitative differences in the uncoated and various coated samples, with the inventors' nanocomposite coating giving the best appearance. Also, the weight loss of the fruit for other coatings were higher than that of the inventors' nanocomposite coating.

Finally, the inventors conducted a sol-gel test to measure the solubility of the coating in water, as consumers might prefer the taste of the fruit without the coating. To demonstrate the washability of the film, a slightly thicker (100 μm) film compared to the actual coating thickness (23˜33 μm) was put into a vial with room temperature DI water. Upon shaking for ˜2 min at room temperature, the film completely disintegrated and dispersed into the DI water (FIG. 4D). This demonstrates that the coating would be easily removable from the fruit peel by rinsing with water and gentle rubbing of the surface, as compared to currently used non-washable wax coatings.

Food waste represents a huge impediment towards eliminating hunger around the globe and extending the shelf-life of perishable food offers a direct solution to this problem. Although various methods have been used to preserve fresh food, they are often limited by manufacturing cost and food safety concerns. An egg protein-based nanocomposite coating was developed for effective freshness preservation. The coating is mechanically robust, easy to produce, possesses extraordinary gas barrier properties, and could be sourced from waste biomaterials as well. Through the demonstration of four fruit models, the inventors showed that the coating can retain freshness, appearance, and aroma for at least one week longer than uncoated samples, validating the universal effectiveness of the coating in preventing fruit rotting. Its edibility (biocompatibility) and washability (solubility) in water also reduce food safety concerns. The inventors believe this work presents an innovative approach to addressing the global food waste problem as an environmentally friendly, highly scalable and low-cost freshness preserver.

TABLE S1
Components used for bio-nanocomposite coating

| | | Content |
|---|---|---|
| Category | Material | (weight/weight) |
| Protein base | Egg white powder | 100% |
| Solvent | Water | — |
| Plasticizer | Glycerol | 30% |
| Fatty acid | Egg yolk powder | 15% |
| Crosslinker, Antioxidant | Curcumin powder | 5% |
| Reinforcement | Cellulose nanocrystal | 30% |

TABLE S2
Zeta potential of CNCs

| Material | Zeta potential (mV) |
|---|---|
| Cellulose nanocrystal | −48.0 ± −2.0 |

TABLE S3
Various deconvoluted diffraction peaks from XRD

| Plane | 2θ | Peak Height | FWHM |
|---|---|---|---|
| II (1-10) | 12.4 | 4747 | 1.81 |
| Iβ (1-10) | 15.0 | 4048 | 1.96 |
| Iβ (110) | 16.5 | 2295 | 1.68 |
| Iβ Amorphous | 18.4 | 1073 | 2.08 |
| II (110) | 20.2 | 2682 | 1.45 |
| Iβ (200) | 22.7 | 10380 | 1.03 |
| II & Iβ (004) | 34.3 | 55 | 0.75 |

TABLE S4
Results extracted from biaxial tensile puncture

| | Ultimate tensile | Breaking | Strain at |
|---|---|---|---|
| | strength (MPa) | Strength (MPa) | break (%) |
| Average | 5.2 | 3.4 | 27.9 |
| Standard Deviation | 2.0 | 1.4 | 13.3 |

TABLE S5
Mechanical properties of packaging materials

| | Tensile | Elastic | |
|---|---|---|---|
| | strength | Modulus | Elongation |
| Materials | (MPa) | (MPa) | (%) |
| Pectin^{[9]} | 2.5-15.0 | 0.5-10 | 3.0-16.5 |
| Starch^{[10]} | 1.6-22.3 | 21-1300 | 3.0-59.0 |
| Protein isolate^{[11]} | 0.2-10.0 | 10-251 | 12-468 |
| pet^{[9]} | 157-177 | 3500 | 70 |
| Carnauba wax | 1.6 | 9.9 | 0.2 |
| Chitosan^{[13]} | 7-42 | 1.0 | 12-72 |
| PLA^{[10]} | 30-70 | 2700-3800 | 4.0-7.0 |
| Low-density polyethylene | | | |
| Ethylene-vinyl alcohol | | | |
| This work | 3.3-3.5 | 250-280 | 10-14 |

* The properties have a broad range based on modifiers used

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

### V. References

The following references, to the extent that they provide exemplary procedural or other details supplementary to those set forth herein, are specifically incorporated herein by reference.
Editorial, Nature 2019, 574, 296.
Global Food Losses and Food Waste—Extent, Causes and Prevention, FAO, 2011.
J.-W. Han, L. Ruiz-Garcia, J.-P. Qian, X.-T. Yang, Compr. Rev. Food Sci. Food Saf 2018, 17, 860.
W. Jongen, Fruit and Vegetable Processing: Improving Quality, Elsevier, 2002.
R. Ahvenainen, Novel Food Packaging Techniques, Elsevier, 2003.
W. Jongen, Improving the Safety of Fresh Fruit and Vegetables, CRC Press, 2005.
D. Bracey, C. D. Holyoak, P. J. Coote, J. Appl. Microbiol. 1998, 85, 1056.
H. A. Krebs, D. Wiggins, M. Stubbs, A. Sols, F. Bedoya, Biochem. J. 1983, 214, 657.
M. Mkandawire, A. N. Aryee, Curr. Opin. Food Sci. 2018, 19, 104.
A. R. Patel, Adv. Funct. Mater. 2020, 1806809.
H. Tao, M. A. Brenckle, M. Yang, J. Zhang, M. Liu, S. M. Siebert, R. D. Averitt, M. S. Mannoor, M. C. McAlpine, J. A. Rogers, D. L. Kaplan, F. G. Omenetto, Adv. Mater. 2012, 24, 1067.
M. M. Rahman, A. N. Netravali, B. J. Tiimob, V. K. Rangari, ACS Sustain. Chem. Eng. 2014, 2, 2329.
J.-W. Chang, C.-G. Wang, C.-Y. Huang, T.-D. Tsai, T.-F. Guo, T.-C. Wen, Adv. Mater. 2011, 23, 4077.
R. J. Moon, A. Martini, J. Nairn, J. Simonsen, J. Youngblood, Chem. Soc. Rev. 2011, 40, 3941.
E. Kontturi, P. Laaksonen, M. B. Linder, Nonappa, A. H. Gröschel, O. J. Rojas, O. Ikkala, Adv. Mater. 2018, 30, 1703779.
A. P. C. Almeida, J. P. Canejo, S. N. Fernandes, C. Echeverria, P. L. Almeida, M. H. Godinho, Adv. Mater. 2018, 30, 1703655.
T. Mekonnen, P. Mussone, H. Khalil, D. Bressler, J. Mater. Chem. A 2013, 1, 13379.
M. M. Rahman, A. N. Netravali, ACS Sustain. Chem. Eng. 2014, 2, 2318.
S. Liu, W. Guo, Adv. Funct. Mater. 2018, 28, 1800596.
J. Wu, J. Wang, J. Zhang, Z. Zheng, D. L. Kaplan, G. Li, X. Wang, ACS Biomater. Sci. Eng. 2018, 4, 3885.
J. Hwang, H. H. Shin, Korea-Australia Rheology Journal 2000, 12, 175.
S. Moser, T. Müller, A. Holzinger, C. Lutz, S. Jockusch, N. J. Turro, B. Kräutler, Proc. Natl. Acad. Sci. 2009, 106, 15538.
S. Moser, T. Müller, M.-O. Ebert, S. Jockusch, N. J. Turro, B. Kräutler, Angew. Chem. Int. Ed. 2008, 47, 8954.
A. Tiessen, Plant Sci. 2018, 275, 75.
B. Marelli, M. A. Brenckle, D. L. Kaplan, F. G. Omenetto, Sci. Rep. 2016, 6, 1.
M. M. Rahman, A. N. Netravali, RSC Adv. 2016, 6, 47101.
S. Farris, L. Introzzi, P. Biagioni, T. Holz, A. Schiraldi, L. Piergiovanni, Langmuir 2011, 27, 7563.
D. Plackett, Biopolymers: New Materials for Sustainable Films and Coatings, John Wiley & Sons, 2011.
S. Beck-Candanedo, M. Roman, D. G. Gray, Biomacromolecules 2005, 6, 1048.
A. Brinkmann, M. Chen, M. Couillard, Z. J. Jakubek, T. Leng, L. J. Johnston, Langmuir 2016, 32, 6105.
A. Sze, D. Erickson, L. Ren, D. Li, J. Colloid Interface Sci. 2003, 261, 402.
J-L. Sormana, S. Chattopadhyay, J. Carson Meredith, Rev. Sci. Instrum. 2005, 76, 062214.
S. Varanasi, L. Henzel, L. Mendoza, R. Prathapan, W. Batchelor, R. Tabor, G. Gamier, Front. Chem. 2018, 6, DOI 10.3389/fchem.2018.00409.
A. M. Barbosa, E. Robles, J. S. Ribeiro, R. G. Lund, N. L. V. Carreño, J. Labidi, Materials 2016, 9, 1002.
C. M. Lee, A. Mittal, A. L. Barnette, K. Kafle, Y. B. Park, H. Shin, D. K. Johnson, S. Park, S. H. Kim, Cellulose 2013, 20, 991.
P. Lu, Y.-L. Hsieh, Carbohydr. Polym. 2010, 82, 329.

What is claimed is:

1. A composition comprising poly-albumen, cellulose nanocrystals (CNCs), and an external plasticizer.

2. The composition of claim 1, wherein said poly-albumen is derived from whole egg or egg white proteins.

3. The composition of claims 1-2, wherein said external plasticizer is a polyol, such as glycerol, ethyleneglycol (EG), diethylene glycol (DEG), triethylene glycol(TEG), tetraethylene glycol, propylene glycol (PG), and/or polyethylene glycol (PEG).

4. The composition of claims 1-3, comprise an anti-microbial and/or anti-oxidant.

5. The composition of claims 3-4, wherein said anti-microbial is curcumin, riboflavin or cinnamaldehyde.

6. The composition of claim 5, wherein said curcumin, cinnamaldehyde and/or riboflavin are crosslinked with said poly-albumen.

7. The composition of claims 1-6, wherein said CNCs are present at about 15-45 wt % of said poly-albumen.

8. The composition of claims 1-7, wherein said external plasticizer is present at about 10-40 wt % of said poly-albumen.

9. The composition of claims 3-8, wherein said anti-microbial and/or anti-oxidant are present at about 1-10 wt % of said poly-albumen.

10. The composition of claims 1-9, further comprising egg yolk protein, such as at about 10-20 wt % of said poly-albumen.

11. The composition of claims 1-10, wherein the CNCs have a length and diameter of less than 1 μm, or less than 500 nm, or less than 250 nm.

12. The composition of claim 11, wherein said CNCs have a length of about 90-130 nm and a diameter of about 4-8 nm.

13. The composition of claim 11, wherein said CNCs have a crystallinity index of about 84%.

14. The composition of claims 1-13, wherein said composition has a basic pH.

15. The composition of claim 14, wherein the basic pH is about pH 8.0-12, or about pH 10.0.

16. A perishable food product coated with the composition according to claims 1-15.

17. The perishable food product of claim 16, wherein said product is a fruit or vegetable, such as a climacteric or non-climacteric fruit or vegetable.

18. The perishable food product of claim 17, wherein said climacteric fruit is apple, avocado, banana, breadfruit, cherimoya, durian, feijoa, fig, guava, kiwifruit, mango, muskmelon, papaya, passion fruit, pears, persimmon, plantain, quince, sapodilla, sapote, soursop, tomato or stone fruit (apricots, nectarines, peaches, plums).

19. The perishable food product of claim 17, wherein said non-climacteric fruit is strawberry, blueberry, blackberry, pineapple, grape, raspberry, cherry, orange, lime, lemon, or grapefruit.

20. The perishable food product of claim 17, wherein said climacteric vegetable is cantaloupe or potato.

21. The perishable food product of claim 17, wherein said non-climacteric vegetable is cucumber, eggplant, pepper, summer squash or watermelon.

22. The perishable food product of claim 16, wherein said product is an egg.

23. The perishable food product of claim 16, wherein said product is a nut, such as a shelled nut.

24. A method of preserving the shelf life of a perishable food product comprising applying the composition of claims 1-15 to the surface of said product.

25. The method of claim 24, wherein applying comprises dipping, spraying, rinsing or painting said product in or with said composition.

26. The method of claim 24, wherein said product is a fruit or vegetable, such as a climacteric or non-climacteric fruit or vegetable.

27. The method of claim 24, wherein said climacteric fruit is apple, avocado, banana, breadfruit, cherimoya, durian, feijoa, fig, guava, kiwifruit, mango, muskmelon, papaya, passion fruit, pears, persimmon, plantain, quince, sapodilla, sapote, soursop, tomato or stone fruit (apricots, nectarines, peaches, plums).

28. The method of claim 26, wherein said non-climacteric fruit is strawberry, blueberry, blackberry, pineapple, grape, raspberry, cherry, orange, lime, lemon, or grapefruit.

29. The method of claim 26, wherein said climacteric vegetable is cantaloupe or potato.

30. The method of claim 26, wherein said non-climacteric vegetable is cucumber, eggplant, pepper, summer squash or watermelon.

31. The method of claim 24, wherein said product is an egg or a nut, such as a shelled nut.

32. The method of claim 24, wherein said (i) applying is performed at ambient/room temperature and/or (ii) applying is followed by drying performed at ambient/room temperature.

33. The method of claim 24, wherein said applying is performed over about 0.5 to about 5 seconds.

34. The method of claims 24-33, further comprising applying the composition at least a second time.

35. A preserved food product made according to the method of claim 26.

36. A method of preparing a food preserving composition comprising:
(a) dissolving poly-albumen in an aqueous solution, optionally including adjusting the pH of the dissolved poly-albumen solution to be at or greater than pH 8.0 and a temperature of 50-80° C.;
(b) adding an external plasticizer to the solution of step (a);
(c) adding cellulose nanocrystals (CNCs) to the solution of step (b).

37. The method of claim 1, wherein said poly-albumen is derived from whole egg or egg white proteins.

38. The method of claims 36-37, wherein said external plasticizer is a polyol, such as glycerol, ethyleneglycol (EG), diethylene glycol (DEG), triethylene glycol(TEG), tetraethylene glycol, propylene glycol (PG), and/or polyethylene glycol (PEG).

39. The method of claims 36-38, the food preserving composition also comprises an anti-microbial and/or anti-oxidant.

40. The method of claim 39, wherein said anti-microbial is curcumin, riboflavin or cinnamaldehyde.

41. The method of claim 40, wherein said curcumin, cinnamaldehyde and/or riboflavin are crosslinked with said poly-albumen.

42. The method of claims 36-41, wherein said CNCs are present at about 15-45 wt % of said poly-albumen.

43. The method of claims 36-42, wherein said external plasticizer is present at about 10-40 wt % of said poly-albumen.

44. The method of claims 39-43, wherein said anti-microbial and/or anti-oxidant are present at about 1-20 wt % of said poly-albumen.

45. The method of claims 36-44, further comprising, after step (b) and before step (c), adding egg yolk protein, such as at about 10-20 wt % of said poly-albumen.
